(19) United States
(12) Patent Application Publication
(10) Pub. No.: US 2010/0327596 A1
(43) Pub. Date: Dec. 30, 2010

(54) Venturi Effect Fluid Turbine

(75) Inventor: Michael Anthony Williams, Corpus Christi, TX (US)

Correspondence Address: MICHAEL ANTHONY WILLIAMS, SR., 977 RIBBONTAIL ST., CORPUS CHRISTI, TX, 78418, US

(73) Assignee: Michael Anthony Williams, Corpus Christi, TX (US)

(21) Appl. No.: 12/490,325

(22) Filed: Jun. 24, 2009

(51) Int. Cl. F03D 9/00; F03D 3/06; F03B 13/00; F03B 3/12

(52) U.S. Cl. 290/54; 416/223 R

(57) ABSTRACT

A Venturi Effect fluid Turbine of a Utility Design, that is fashioned in such a way as to maximize energy production from fluids in motion, by mechanically creating a vortex that reduces fluid pressure at the axis of rotation of said art device, thereby causing the free stream velocity to increase as a function of said vortex.

Upon a fluid impacting the airfoil(s) or hydrofoil(s) leading edge, a reduction in fluid pressure begins on the curved outside surface of the airfoil(s) or hydrofoils and continues to decrease as the trailing edge is approached by said fluid flow. The difference in fluid flow velocity between the curve side and the concave side of the airfoil(s) or hydrofoil(s) creates a venturi effect at the boundary layer where the low pressure fluid flow of the curve side impacts the higher pressure fluid flow of the concave side.

### FIELD OF THE INVENTION

The present invention relates to the field of wind turbines, and in particular, relates to vertical axis wind turbines (VAWT) and horizontal axis wind turbines (HAWT).

By definition wind and water currents are fluids in motion; a priori, the present invention relates to the field of hydro turbines as well.

An aircraft wing, propeller, or rotor blade generates a lifting force due to the airfoil shape, angle of attack and velocity of air flow over said device surface. Each device is efficient at generating lift in its domain. The aircraft wing generates the most lift as compared to the other devices due to its relative size.

Typically aircraft wings are fashioned using a central spar, with ribs in the shape of a particular NACA airfoil design, aligned linearly along said spar. However it is possible to utilize the same aircraft wing design to fashion an omni axis fluid turbine. This is accomplished by rotating said ribs in a helical fashion along said spar causing the wing surface to twist. In this configuration, a plurality of “wings” (airfoils-hydrofoils) can be affixed to the (central axis) spar.

It is then possible to conclude that the surface area of a propeller, that is used in a horizontal axis wind turbine, can be fashioned in the aforementioned manner to occupy an area significantly smaller than that of said horizontal axis wind turbine, while delivering greater energy output. Thus the present art device Venturi Effect Fluid Turbine.

### BACKGROUND OF THE INVENTION 2009 and the global economic crash has ushered in the age of green. The United States of America has reached the end of a glorious and prosperous road built upon fossil fuels and manufacturing of products, by humans, at a comparative advantage. Robotics combined with cheap foreign labor and equal or superior quality imported products has led to the demise of the American manufacturing heartland.

As a single nation, the United States of America has the largest area of usable wind resource for generating electricity, at a cost less than or equal to that of fossil fuel electricity generation plants (without adverse effects on the environment). While the vast majority of the Earth's estimated 72 Terra watts (tw) of wind resource is over open oceans, the United States of America and its territories have approximately 10% (3.2 tw) of the remaining 32 Terra watts of wind resource within its borders.

The United States of America could become a leader in “Green” energy production, giving this Nation an export commodity equivalent to our current import of crude oil from the middle east. It is therefore envisaged that America's demand for wind energy appliances will be such that sufficient numbers of devices will be marketed for domestic use, giving domestic manufactures a comparative advantage over foreign devices, creating an export market for wind and hydro turbines made in the USA.

Wind, wave, and water currents are being increasingly used to generate electrical power in diverse places on Earth. Most notably are the large wind farms employing horizontal axis turbines with tower heights reaching 100 meters. However, this type of device has several disadvantages, including noise pollution, wild life hazard, air traffic obstruction, visual pollution with formations of wind turbines with large diameter propellers (which under certain conditions) reach or exceed supersonic speed at the blade tips. Also, they are impractical for residential and commercial use in urban and space restricted areas. Despite the short comings, it is widely believed that horizontal axis wind turbines are more efficient than vertical axis wind turbines.

Another potential source for green energy production, in the United States, are the numerous rivers and the Gulf Stream where hydro turbines could be installed. Florida Atlantic University's, Center of Excellence in Ocean Energy Technology, is undertaking a project to tap the gulf stream as a source for renewable energy. Prior art devices incorporate the use of horizontal axis hydro turbines and vertical axis hydro turbines.

Vertical axis wind turbines typically have a central vertical rotor section having a series of rotor blades or “buckets” that serve to rotate the turbine around a central axis when a wind, from any direction, impacts the wind turbine. While a horizontal axis wind turbine must turn to face into the wind, the orientation of a vertical axis wind turbine remains unchanged regardless of wind direction. This reduces the design complexity of the turbine making it ideally suited for urban and rural use.

The “Savonious-” wind turbine U.S. Pat. No. 1,697,574, is a aeronautical drag device that utilizes “buckets” to capture wind energy. The most familiar version of this device is the anemometer that is used to measure wind speed.

An improvement on the Savonious-type” wind turbine is the “Syntrefoil” Pat. No. D569490 which utilizes a spiral design array of buckets that more effectively captures wind, by orientating more buckets in to the free stream than prior art device Savonious-type.

A further improvement on the “Savonius-type” wind turbine is the “Helical wind Turbine”, U.S. Pat. No. 7,344,353. It is a vertical wind turbine that has a non-linear rotor configuration. The “Helical Wind Turbine” improves on the “Savonious-type” replacing the buckets with a set of “rotors” that span the length of central axis, adding a lift component to the rotational moment however, the design does not allow all rotors to capture energy from the wind simultaneously, during each revolution cycle, nor does the “vertical vortex of air”, as claimed, effectively increase the velocity of the free stream air flow or decrease the pressure of the air flow through said prior art device.

Another type of vertical axis wind turbine is the Darrieus EP No. 1335130 which uses airfoils that resemble an “egg-beater” to generate a rotational moment.

U.S. Pat. Application No. 20020109358 “Omni-Directional Vertical-Axis Wind Turbine” improves upon prior art vertical devices by eliminating the problem of the rotor exposed to the force of the wind during only one-half of each cycle. The “Omni-Directional Vertical-Axis Wind Turbine” claims to take advantage of the Venturi and Coriolis effect to cause an air pressure reduction through the use of a complex set of rotors and stators. However, as claimed, the prior art device does not effect the velocity or pressure of the free stream, only the internal air pressure of said prior art device.

U.S. Pat. No. 6,409,466 teaches a prior art device “Hydro Turbine” where said device “is a water driven turbine for converting the energy of an underwater current comprising: a hollow tubular open ended housing, said housing having an entry end for accepting the water and an exit end for releasing the water.”

### SUMMARY OF THE INVENTION

Accordingly, it is therefore an objective of the present invention to provide an omni axis fluid turbine, which more efficiently enables capture of fluid energy than prior art devices. An omni axis fluid turbine that allows all airfoil(s) or hydrofoil(s) to generate a rotational force during a revolution cycle operating more efficiently than prior art devices.

If the central axis has a vertical orientation then a priori it will rotate when impacted by a force of a fluid. Likewise if the central axis is rotated to a horizontal orientation the same result can be expected. Further, If the fluid flow is parallel to the orientation of the central axis a rotational moment will result. In this regard the present art device will generate a rotational moment regardless of central axis orientation, relative to the free stream fluid flow.

Further objects of the invention will be apparent from review of the disclosure, drawings and description of the invention below. However, the advantages set out herein above, as well as other objects and goals inherent thereto, are at least partially or fully provided by the fluid turbine of the present invention, as set out herein below.

In a preferred embodiment, each airfoil or hydrofoil has an inner surface, an outer surface, two ends, a leading edge and a trailing edge located nearer to the center rotational axis. Further, each trailing edge of each airfoil or hydrofoil is and wherein the remainder of the airfoil or hydrofoil has a helical configuration. As such, in its most preferred embodiment, the airfoils or hydrofoils of the omni axis fluid turbine, of the present invention, have a non-linear trailing edge and a helical surface configuration.

The present invention also functions as a vortex generator. The rotating airfoils or hydrofoils generate a decreasing area of low pressure from leading edge to trailing edge, allowing the present invention to rotate more efficiently due to a reduction in fluid pressure and dynamic drag.

In a still further aspect of the present invention, a Venturi Effect fluid Turbine, of sufficient size, would necessarily cause the free stream fluid flow (either perpendicular or parallel to the axis of rotation) to accelerate due to the low pressure area that exists at the center of rotation of said Venturi Effect fluid Turbine, which describes a vortex due to the rotational moment.

Another aspect of the present invention, reduces fluid pressure at the center of axis of rotation which in turn causes a reduction in fluid temperature in a gradient surrounding said present invention fluid turbine and expanding outward; which contributes to an increase in velocity of the free stream fluid flow perpendicular to the axis of rotation.

The summation of the aforementioned attributes increases the efficiency of said present invention fluid turbine as a cube function of the variation in free stream velocity, thus increasing the kinetic energy the fluid exerts on said present invention fluid turbine.

Another aspect of the present invention; by increasing the number of airfoils fluid pressure can be reduced (approaching a vacuum, in air, at the trailing edge central axis at sufficient rotational velocity) further reducing aerodynamic drag and increasing rotational moment.

It is still another objective of the present invention to satisfy the “aesthetics” of introducing large numbers of vertical or horizontal fluid turbines in urban areas, and in some rural areas, that might be considered “scenic” such as national parks. An important aspect of the present invention is its appealing shape (helix) which lends itself to decorative “artwork”.

A further aspect of the present invention allows the surface material of the fluid-foil(s) a to be covered with a solar voltaic film to capture energy from the sun or a nano-fabric that allows the surface of the fluid-foil(s) of the present invention, to change color, camouflaging said fluid turbine's appearance and enhancing its public acceptability.

Another aspect of the present invention allows sizing to match said fluid turbine to the operating environment. The total force generated by said fluid turbine is a function of the total area of the airfoil(s) or hydrofoil(s). Space limitation factors can be compensated for by the addition of airfoil(s) or hydrofoil(s), thereby reducing the height and diameter of said fluid turbine while maintaining the same energy output per unit of fluid.

A final aspect of the present invention will allow continuous operation in fluids exceeding 20 msec through the use of a continuously variable transmission.

Therefore, the present invention is an improvement to standard art vertical and horizontal wind and water machines by providing: (1) A substantial decrease in the fluid pressure near airfoil or hydrofoil trailing edge, reducing aerodynamic or hydrodynamic drag and increasing resultant kinetic energy provided by the airfoil(s) or hydrofoil(s) camber, taper, (diameter/height) ratio and 180 degree helical twist. (2) A further increase in the rotational moment results from the venturi effect or negative pressure created by helical circumferential fluid-flows around the airfoils or hydrofoils, resulting in an acceleration of the free stream. (3) Aesthetic features that help assuage public concern of visual pollution issues. (4) Silent operation and environmentally friendly to wildlife. (5) Finally the present invention can be deployed in diverse places where there is sufficient fluid speed for operation.

### BRIEF DESCRIPTION OF DRAWINGS

The best method for carrying out the fabrication of the invention will be understood from the detailed description of the preferred embodiments illustrated in the accompanying drawings in which:

FIG. 1 is a three dimensional side view of a Venturi Effect Fluid Turbine configured with four airfoils or four hydrofoils.

FIG. 2 is an four airfoil or four hydrofoil configuration of said art device as viewed from the central axis.

FIG. 3 is a three dimensional side view of a Venturi Effect Fluid Turbine configured with six airfoils or six hydrofoils.

FIG. 4 is an six airfoil or six hydrofoil configuration of said art device as viewed from the central axis.

FIG. 5 is a three dimensional side view of a Venturi Effect Fluid Turbine configured with eight airfoils or eight hydrofoils.

### DETAILED DESCRIPTION OF THE DRAWINGS

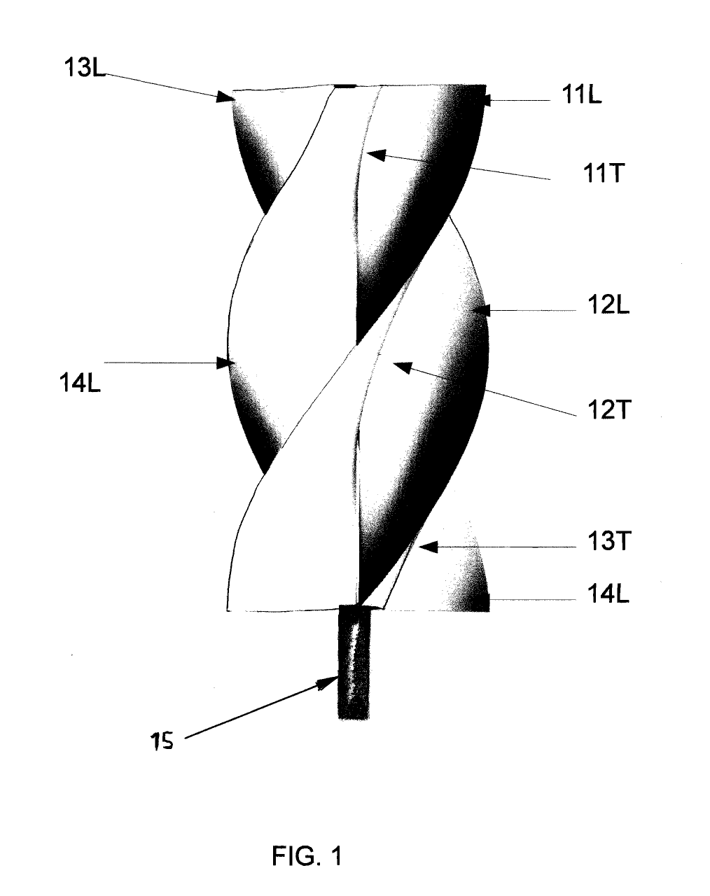

Referring to FIG. 1 of the drawings, Venturi Effect fluid Turbine with four airfoil(s) or hydrofoil(s), 11L -11T, 12L-12T, 13L-13T, 14L-14T. (The letters L and T denote leading edge and trailing edge respectively.)

Referring to FIG. 1. of the drawings the spar 15 that serves as a shaft that connects to a continuously variable transmission (CVT), directly to an electric generator or indirectly to an electric generator through the use of belt and pulleys.

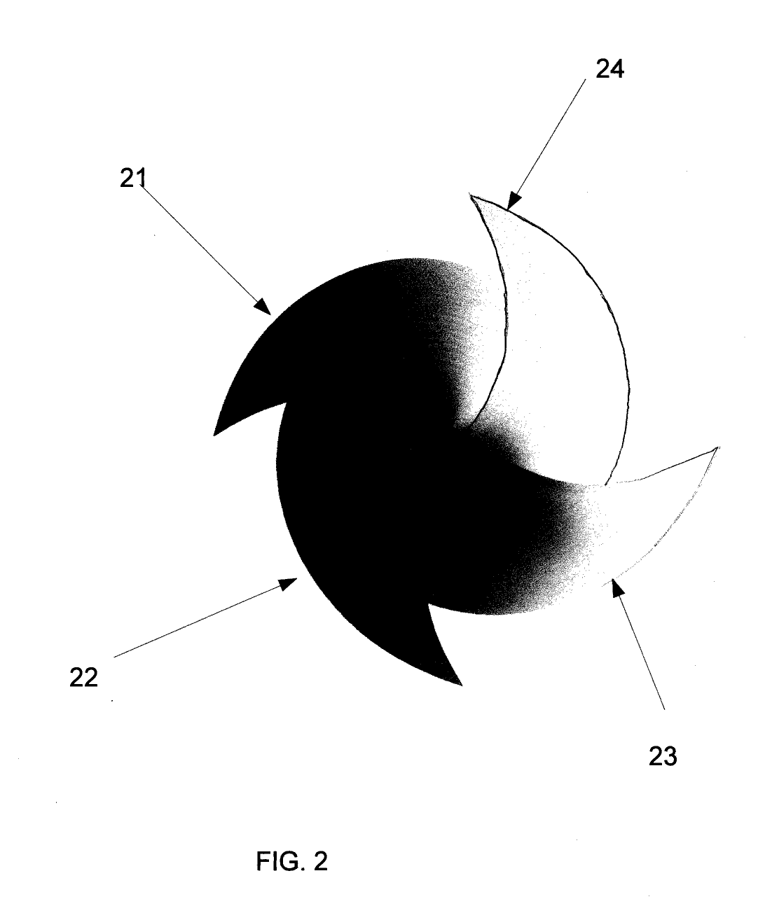

Referring to FIG. 2. of the drawings 21, 22, 23, 24 depict the curved side and the concave side of the airfoil(s) or hydrofoil(s) of said art device as viewed from the central axis.

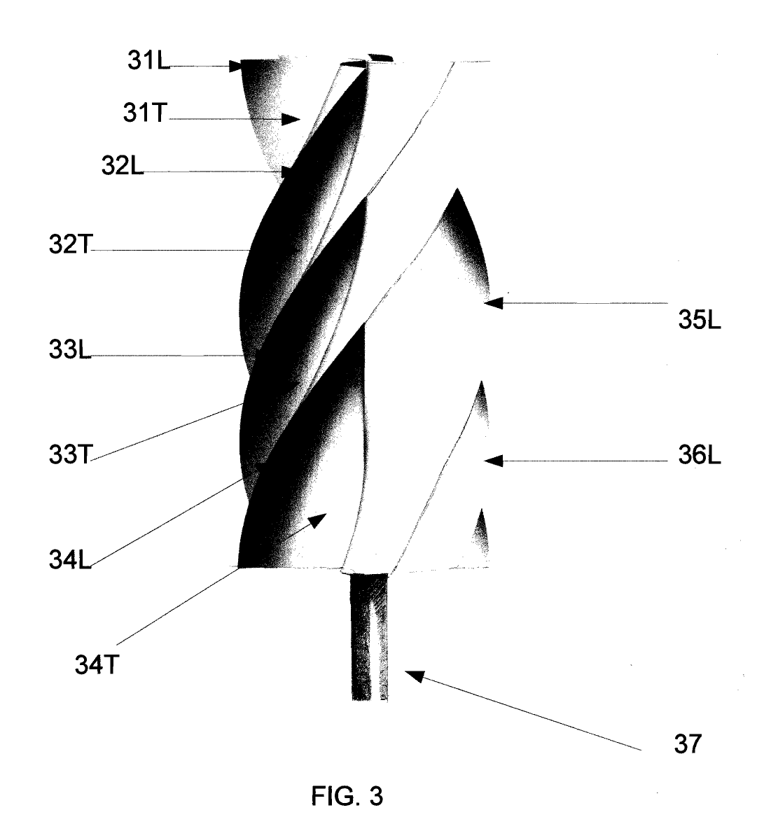

Referring to FIG. 3 of the drawings, Venturi Effect fluid Turbine with six airfoil(s) or hydrofoil(s), 31L-31T, 32L-32T, 33L-33T, 34L-34T, 35L-35T, 36L-36T (The letters L and T denote leading edge and trailing edge respectively.)

Referring to FIG. 3. of the drawings the spar 37 that serves as a shaft that connects to a continuously variable transmission (CVT), directly to an electric generator or indirectly to an electric generator through the use of belt and pulleys.

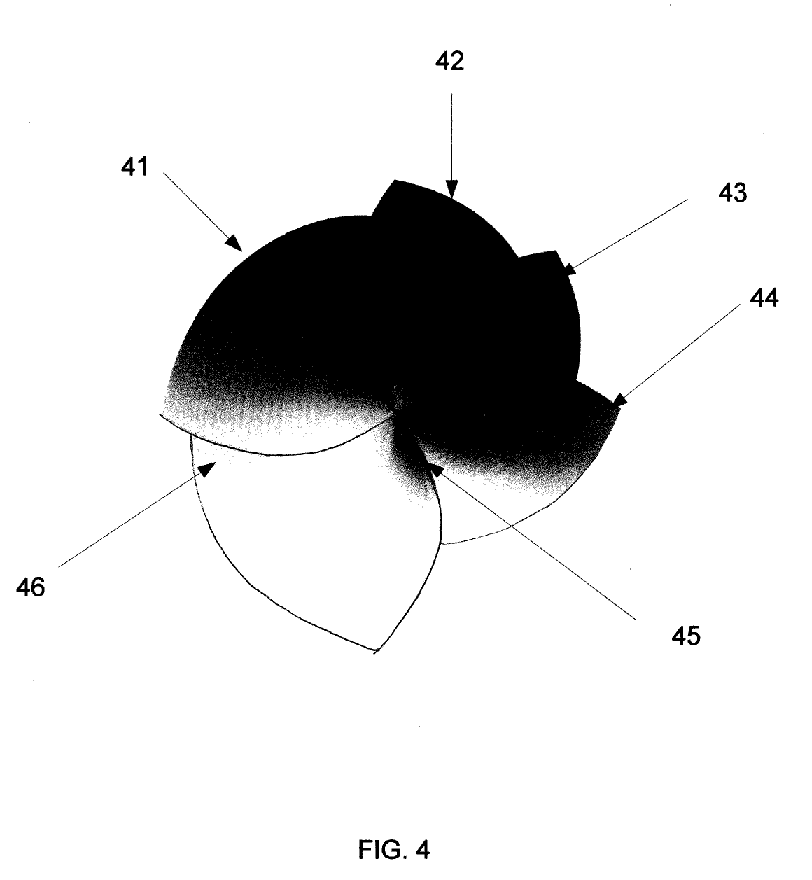

Referring to FIG. 4 of the drawings 41, 42, 43, 44, 45, 46 depict the curved side and the concave side of the airfoil(s) or hydrofoil(s) of said art device as viewed from the central axis.

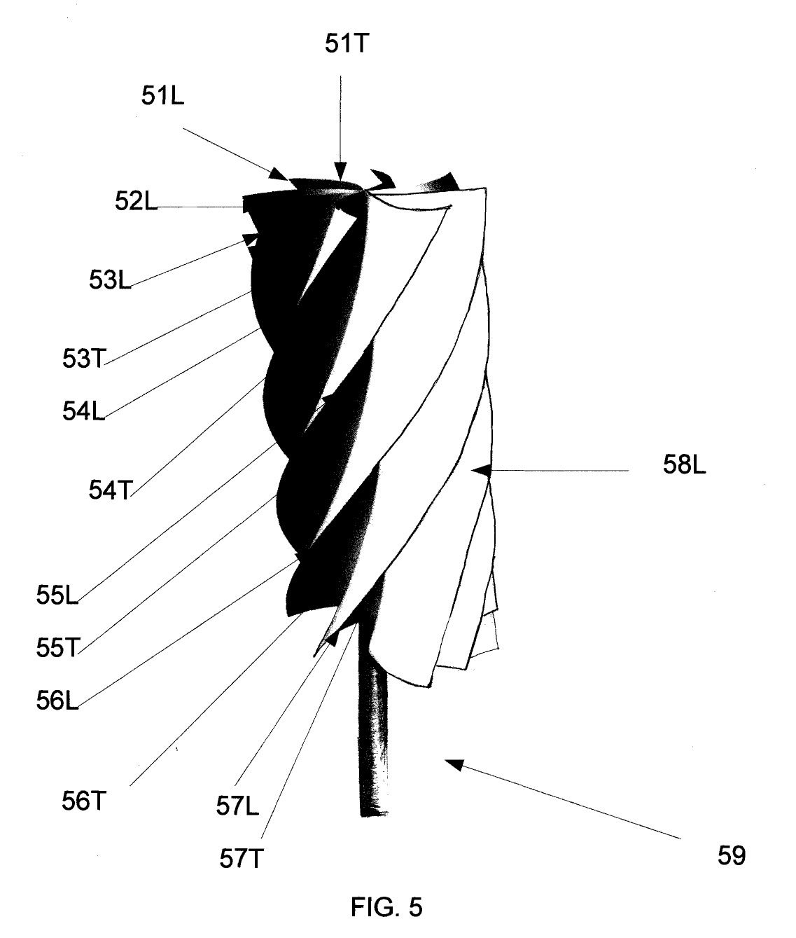

Referring to FIG. 5 of the drawings, Venturi Effect fluid Turbine with six airfoil(s) or hydrofoil(s), 51L-51T, 52L-52T, 53L-53T, 54L-54T, 55L-55T, 56L-56T, 57L-57T, 58L-58T (The letters L and T denote leading edge and trailing edge respectively.)

I claim:

1. An omni axis fluid turbine having a plurality of airfoil(s) or hydrofoil(s) for collection of energy from a fluid in motion for electricity generation. A central spar which serves as a shaft for rotation, affixed to an electrical generator either directly or through a transmission, continuously variable transmission (CVT), or indirectly through a system of pulleys and belt.

2. Where said airfoil(s) or hydrofoil(s) have a spiral design so as to provide a venturi effect for both rotation and lifting force as a result of fluid impacting said art device. Each airfoil(s) or hydrofoil(s) has a positive camber with the upper camber greater than or equal to the lower camber and a 180 degree helical twist. A maximum airfoil(s) or hydrofoil(s) thickness ranging from 0.02-0.09 percent of fifty (50) percent said art device diameter, tapering to approximately zero at the leading edge of said art device.

3. An omni axis fluid turbine as claimed in claim 2 wherein said trailing edges of said airfoil(s) or hydrofoil(s) define a central open area along a central rotational axis of said art device.

4. An omni axis fluid turbine as claimed in claim 3 where said airfoil(s) or hydrofoil(s) overlap the rotational axis so as to prevent fluid from passing through said fluid turbine without impacting said airfoil(s) or hydrofoil(s), regardless of fluid direction or orientation of said art device.

5. An omni axis fluid turbine as claimed in claim 4 comprising a plurality of airfoil(s) or hydrofoil(s) and said airfoil(s) or hydrofoil(s) are circumferentially equally spaced apart about the central axis in an annular array.

6. An omni axis fluid turbine as claimed in claim 2 wherein said airfoil(s) or hydrofoil(s) are orientated to provide a positive lifting force.

7. An omni axis fluid turbine as claimed in claim 2 wherein said airfoil(s) or hydrofoil(s) have a tapered horizontal cross-section width throughout their length.

8. An omni axis fluid turbine as claimed in claim 2 wherein said fluid turbine has an overall height of between 0.6 and 30 meters, a diameter of between 0.3 and 15 meters, a length to diameter ratio ranging from 1:1 to 3:1 and said central open area is between 10% and 75% of the overall said fluid turbine diameter.

9. An omni axis fluid turbine as claimed in claim 1 that provides for silent operation.

10. An omni axis fluid turbine as claimed in claim 1 fashioned in the form of a helix with sufficient airfoil surface that allows “artwork” adornment to be affixed to said surface.

11. An omni axis fluid turbine as claimed in claim 10 fashioned in the form of a helix where the airfoil surfaces can be covered with diverse films and materials that allow said omni axis fluid turbine to camouflage its appearance and or generate electricity from the sun.
